(19) United States
(12) Patent Application Publication
(10) Pub. No.: US 2010/0179951 A1
(43) Pub. Date: Jul. 15, 2010

(54) SYSTEMS AND METHODS FOR MAPPING ENTERPRISE DATA

(76) Inventor: Lon Daniel McPhail, San Diego, CA (US)

Correspondence Address: PILLSBURY WINTHROP SHAW PITTMAN LLP, ATTENTION: DOCKETING DEPARTMENT, P.O BOX 10500, McLean, VA, 22102, US

(21) Appl. No.: 12/397,297

(22) Filed: Mar. 3, 2009

Related U.S. Application Data
(60) Provisional application No. 61/033,382, filed on Mar. 3, 2008.

(51) Int. Cl. G06F 17/30

(52) U.S. Cl. 707/740; 707/756; 707/752; 707/E17.006; 707/E17.089

(57) ABSTRACT

Systems and methods for mapping enterprise data are described. Information associated with an enterprise is obtained from a plurality of sources and transformed to obtain formatted data. The formatted data is orchestrated and relationships between portions of the formatted data are determined from which business intelligence related to the enterprise is obtained. A plurality of analytics is performed on the formatted data and business intelligence.

### CROSS-REFERENCE TO RELATED APPLICATIONS

The present Application claims priority from U.S. Provisional Patent Application No. 61/033,382 filed Mar. 3, 2008, which is incorporated by reference herein in its entirety.

### BACKGROUND OF THE INVENTION

1. Field of the Invention

The present invention relates generally to enterprise software and analytics and more particularly to corporate performance management and business intelligence.

2. Description of Related Art

Currently deployed business intelligence and business analytics technologies have limited mapping, integration, and predictive modeling abilities. Most companies currently focus on the past and have piecemeal information to make decisions. Today's business intelligence technology can bring parts of the enterprise into focus but falls short of allowing full understanding of the holistic business organism. For example, a national car rental company with $15B in fleet trying to minimize its fleet inventory (e.g. identifying $800m in savings) while maximizing revenue. There is a need to model the factors of demand coupled with exigent and dynamic market conditions (e.g. conferences, major migration patterns, etc.).

### BRIEF SUMMARY OF THE INVENTION

Certain embodiments of the invention provide systems, methods, processes and tools for mapping enterprise data. In some of these embodiments, a framework (the “Luminosity Framework”) is employed. Additionally, systems and methods for dynamic enterprise simulation are provided. Certain aspects of the present invention may applied and enhance enterprise software and analytics. In particular, certain embodiments extend the reach of corporate performance management (“CPM”), business process management (“BPM”) and business intelligence (“BI”) using innovative mapping, integration, and predictive modeling technologies.

### BRIEF DESCRIPTION OF THE DRAWINGS

FIG. 1 illustrates DES in comparison to Business Intelligence (BI).

FIG. 2 illustrates a conceptual architecture according to certain aspects of the invention.

FIG. 3 illustrates Luminosity Framework ontology fields through which mapping may be captured.

FIGS. 4-9 are screenshots illustrating certain aspects of the Luminosity Framework mapper.

FIG. 10 depicts a searchable query engine.

FIG. 11 depicts a view of previously-built queries.

FIG. 12 illustrates high-level mapping of an Enterprise.

FIG. 13 provides an example of a detailed Dynamic Enterprise Simulation (DES) Dataflow

FIG. 14 depicts how a mapper validates process output.

FIG. 15 depicts how DES enables run-time verification of enterprise reporting settings and configurations.

FIGS. 16-18 illustrates DES interactions with mapper and modelers.

FIG. 19 illustrates a compare tools according to certain aspects of the invention.

FIG. 20 illustrates a trend analysis tool according to certain aspects of the invention.

### DETAILED DESCRIPTION OF THE INVENTION

Embodiments of the present invention will now be described in detail with reference to the drawings, which are provided as illustrative examples so as to enable those skilled in the art to practice the invention. Notably, the figures and examples below are not meant to limit the scope of the present invention to a single embodiment, but other embodiments are possible by way of interchange of some or all of the described or illustrated elements. Wherever convenient, the same reference numbers will be used throughout the drawings to refer to same or like parts. Where certain elements of these embodiments can be partially or fully implemented using known components, only those portions of such known components that are necessary for an understanding of the present invention will be described, and detailed descriptions of other portions of such known components will be omitted so as not to obscure the invention. In the present specification, an embodiment showing a singular component should not be considered limiting; rather, the invention is intended to encompass other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the components referred to herein by way of illustration.

For the purposes of this description, the definition of data and data element will include any electronically handled piece of information and the definition of an enterprise is understood to encompass the entire sphere of relevance which any give business, agency, or other financially-discreet entity would normally consider influencing to that entity.

For the purposes of this description, a Factor is understood to be a data element that has no influencing child data element, and a Metric is understood to be a data element with both child and parental data points which are influenced. For the purposes of this description, a Report is understood to be a data element with no parental data element being influenced, and the initial entry point of any data element into the enterprise-relevant sphere of influence.

Certain embodiments provide tools for simulation and optimization that employ dynamic enterprise simulation (DES) and optimization models. These tools can be used, in combination or independently, to integrate data regardless of the number and type of systems using software, systems and business common ontology employed. These tools can enable decoding of information and data and provide access to information regardless of its location within an enterprise to customized business models. Accordingly, embodiments of the invention enable empirically informed operators, promote agile operational decisions, and facilitate performance optimization, in mathematical and\or conceptual senses.

The underlying factors of strategic and tactical decision-making are often complex, and business entities have employ a variety of systems including, for example, Oracle, SAS, JD Edwards, SAP, etc. Regardless of the number and type of target data sources, these independent and/or combined capabilities are designed to decode the enterprise information maze, placing the user in control of even the most complicated enterprise. And, as most enterprises do not operate within a single system, these capabilities allow the user to readily traverse a heterogeneous multi-system environment. These capabilities additionally enable an enterprise to gain additional value out of its data warehouse and business intelligence (BI) investments by including pre-existing systems in order to augment and enhance the overall enterprise capabilities and vision.

Such holistic understanding of the enterprise can enable control of the causal relationship set, expanding beyond a few Key Performance Indicators. This capability set harnesses data from heterogeneous environments, making data available to customized models that are harnessed within the Luminosity Framework and DES robust platform. Benefit accrues derived because these capabilities help users understand, measure, then simulate and optimize their performance while understanding, quantifying, valuing, and ranking mitigating business and accounting risk. Radically transforming the quality of the decision support information, users of these capabilities will routinely make better informed choices and thus illicit greatly enhanced actionable intelligence-based decision streams and performance.

Certain embodiments of the invention provide systems and methods for enhancing the performance and capabilities of enterprise software and analytics, particularly with regard to corporate performance management and business intelligence. The novel systems disclosed herein improve and add to the art in variety of ways.

In certain embodiments, methodologies are employed that map an enterprise, typically using a Luminosity Framework. These methodologies can comprise a mapper that captures the relational, algorithmic, risk, behaviors, and other discriminating ontological classifications in its mapping. The mapper may retain relational values of concern such as identification of users, frequency of use of identified data by the users and the frequency of refresh of the identified data. The methodologies can also comprise an enterprise ontology that may be applied to the mapper. A mapper ontology according to certain aspects of the invention is sufficiently robust to capture, catalogue, and classify both the location and behaviors of the data, as well as other factors which characterize both its relevance and importance across the enterprise. These factors can be large in number and typically include 50 or more elements.

The methodologies can also comprise functional elements borrowed from the existing art as well as novel customized components that can capture the relational construct of an enterprise in a multi-dimensional database which provides increasing value, where other art is constructed through interviews and scribes noting factors onto paper. Once the relations are captured in a suitable BI tool, the mapping function typically ceases to provide additional value. Examples of BI tools can be found in the art.

The methodologies can also comprise tools and systems that enable business users to interact with enterprise data. Integrated tools can be deployed to deliver capabilities through easy to understand, common business language terminology, and within a navigable, easily discernable construct. A typical user needs only to log in to the mapper in order to explore the relational cause and effect of all data elements, where other art conceals such values and abilities above the ability of anyone other than a highly-skilled programmer.

The methodologies can also comprise systems and methods for integrating otherwise unrelated data. It will be appreciated that the systems and methods provided accomplish complete interoperability with data formats and programming environments including compliance with standard environments that include XML, MOSA and NESI standards, for example.

Certain embodiments of the invention comprise a plurality of methods and tools organized as a set of elements that may be used alone or in combination. In one example, a suite of tools may comprise thirteen individual elements that facilitate mapping and using enterprise data to create static and dynamic enterprise simulations. In the example, twelve of the elements may function in a self-standing manner; however, the aggregation of any two or more components typically yields additional and greater capabilities than provided by any individual component.

The suite of tools is logically divided into categories, including anchor, core, advanced, and premier tools. These terms are arbitrarily selected as a means to group the tools and other names and groupings are contemplated. Anchor tools may comprise a mapper (such as the Luminosity Mapper™ provided by KUITY Inc.). The mapper can facilitate identification and mapping of factors and metrics to “entity” data from the top level to the field level to raw inputs. For example, the mapper can facilitate the identification and mapping of factors and metrics to an Enterprise's data from top level to the field level. The mapper may also facilitate understanding of data systems and information systems and can identify precisely drivers used in making business decisions. The mapper can capture periodicity (e.g. creation and frequency) and data touch points, such as who creates data, who assembles data, who consumes/reads data, etc.

Anchor tools may comprise a reporting tool (such as the Luminosity Reporter™ provided by KUITY Inc.) that enables a user to design and invoke reports based on user-defined needs, and create preconfigured (“canned”) reports desired and determined by the user. In one example, users can modify templates at any time and as needed or desired, leveraging an XML reporting data structure that allows for portability into many report writing applications (i.e. Crystal Reports™, etc.). Thus users obtain flexibility and ease of use while recurring life-cycle costs due to report modification needs and/or requests can be substantially reduced.

Anchor tools may comprise a modeling tool (such as the Luminosity Modeler™ provided by KUITY Inc.) that can facilitate crunching of mapped factors and/or metrics, modeling, and visual rendering of same in manner that facilitates robust understanding of the enterprise condition while also allowing business operators to evaluate alternative hypothetical scenarios.

Core tools may comprise a gateway (such as the Luminosity Gateway™ provided by KUITY Inc.) that can provide an interface to manufacturing process modeling tools, CRM, ERP, etc., such that business-relevant data driving the enterprise, manufacturing capability optimization, and risk identification can be integrated with the modeler.

Core tools may comprise a proofing tool (such as the Luminosity Proof™ provided by KUITY Inc.) that can use process and sniffing capabilities to automatically collect, verify, and associate a work product with prescribed process step, thereby facilitating automatic and continual audit.

Core tools may comprise a trend analysis tool (such as the Luminosity Trend™ provided by KUITY Inc.) which can facilitate business drivers and risk identification via real-time trend analysis of business activities. Using sniffer capabilities, trends and unknown associations can be realized by identifying unexpected correlations. The trend analysis tool can identify important trends based on collected enterprise data.

Core tools may comprise an audit tool (such as the Luminosity History™ provided by KUITY Inc.) that can employ sniffing technology in order to facilitate storage and replay of all business activity within a selected time window. The audit tool enables monitoring of and defense against internal and external risks. Software can correlate specified activity with any other related activity.

Advanced tools may comprise a process management tool (such as the Luminosity Process™ provided by KUITY Inc.). A process management tool can facilitate the threading of key business processes. Compliance management (including SOX) can then be orchestrated with regularity and ease.

Advanced tools may comprise an optimization tool (such as the Luminosity Process Optimization Modeler™ provided by KUITY Inc.). In one example, an optimization tool may be embodied as a process modeling engine that facilitates mathematical evaluation of the impact of varying process configurations and their impact, thereby enabling an ability to optimize processes by selecting viable and efficient configurations. Optimization tools may be used in conjunction with a process and a mapper to enable identification of time delays in a system thereby reducing information latency and elongating lead time for decision-making and corrective action. Thus, certain aspects of the invention enable the enterprise to become highly adaptable and nimble.

Advanced tools may comprise business function specific tools. In one example, a human resources tool (such as the Luminosity HR™ provided by KUITY Inc.) can map business tasks to roles, expose efficiency opportunities by assigning appropriate resources (i.e. lower cost labor), facilitate manpower planning. In some embodiments, a human resources tool may be tied to ERP/CRM and other business information systems. Advanced tools may comprise a benchmarking tool (such as the Luminosity ScoreCard™ provided by KUITY Inc.) that renders internal score results with other relevant and available company benchmarks. In another example, a tool (such as the Luminosity MyScoreCard™ provided by KUITY Inc.) can score accounting and business risk and strength. Additionally, an advanced tool (such as the Luminosity ScoreCard Compare™ provided by KUITY Inc.) can be embedded within the software suite to facilitate comparisons between best business practices and larger business practices, including financial and other indicators of business health.

Premier tools may comprise automated tools that can overlap and/or include business specific function tools described above. Other automated tools may perform automatic mapping (e.g., Luminosity AutoMapper™ provided by KUITY Inc.), and in particular, mapping functions of the vast majority of enterprise data, utilizing network and database sniffer technology and advanced algorithms to determine the formal, functional, and power-based relationships within an organization. All information traffic can be related to/against those structures to primarily classify data relations. In some embodiments, an automatic mapping tool can recursively relate previously classified data to organizational structures allowing for the ontology mapping of remaining fields. Advanced algorithms can determine shifts in unstructured data within the previously ascertained structures to further refine the classifications.

Certain embodiments of the invention provide systems and methods for dynamic enterprise simulation (DES) that provides capability to represent, model, and provide an analytic test bed for enterprise data. DES may comprise the methods, tools, and processes discussed herein to first localize enterprise data, map data relationships to other data, and then associate various attributes to each data point in such a way that a call upon a given attribute will result in a response from all data tagged with that attribute. In one example, these attributes include an XML-based data source ‘address’ and a unique XML-based data element tag.

Next, DES presents this mapped enterprise with select attributes to a DES-compliant modeling engine which is able to accept the mapped construct, interpret the XML tags in the example, and recreate the enterprise as-mapped for user interaction. The DES-compliant modeler of the example, using XML addressing and XML data tags, passively taps all mapped data inject points, and begins to populate the DES modeler. Once populated with a combination of run-time and historical data, the DES modeler enables the user to initiate advanced analytics and what-if test scenarios by providing interrupt values at the exact points within the modeled hierarchal construct. Lastly, DES-compliant applications or features may be added to DES to provide additional, robust capability.

In certain embodiments, DES-compliant tools include a mapper, a reporter, a modeler, a gateway, a proofing tool, a trend analysis tool, a historical/audit tool, a process mapper, a process optimization tool and an automatic mapper.

The mapper facilitates identification and mapping of factors and metrics to “ENTITY” data from the top level to the field level to raw inputs; facilitates understanding of data/information systems and precisely where drivers used for decision making reside both within internal and external sources; captures relationships between the factors and metrics; captures periodicity (creation and frequency); captures data touch points (creation source, assembly source, etc.); amongst other numerous factors.

The mapper is typically a web-based application which interfaces with a local multi-dimensional database backend. Mapper allows the user to log Threads which hold the ontology data attributes, then provides a capability to link threads in parent/child relationships via the use of one-to-many relational links against table primary keys.

The reporter provides support for queries. Once linked, the mapper database can return the same populated ontology to the self-contained query engine, which enables mapper's advanced and unique querying capability.

The modeler is typically a multi-dimensional database which can be dynamically refined as the mapper reports changes to the mapped enterprise construct. The rule set governing modeler's self-modification capability can be structured so that each time a modification to the map is made, a secondary data-interrupt field is created and linked. This data-interrupt linkage may enable DES-compliant models to be able to conduct what-if scenarios with run-time data. Modeler may additionally provide an ability to execute custom analytics using the baked-in analytics tool-set, and may be augmented with another DES-compliant analytics package.

Gateway, in one embodiment, is a columnar database constructed to permit line-rate mapping of one data definition to another as designated by a user. Graphic user interfaces make pick-n-click mapping possible, and elements which are recommended for association are determined by the closeness in proximity to its potentially-related data type source.

In certain embodiments, proofing tools comprise a multi-dimensional database which captures shadow copies of artifacts previously linked to a process step, so that future accounting may take place. Business process management rule sets may be employed to monitor and detect the state changes in the process management engine, while mapped report storage locations are monitored for artifact movement.

Trend analysis tools may include a multi-dimensional database which communicates with a DES-compliant server, and which tracks the XML (for example) values of designated threads within both the subject enterprise, and that of all other enterprises containing the same value type.

The history/audit tool is typically a line-rate bit-level recorder which enables the user to replay a selected period of time, and reconstitute subject matter of interest.

In one example, the process mapper is an application-wrapped algorithm which interfaces with the mapping engine, and determines the mapped process, the actual process taking place, and the differential between the two.

Process optimization modeler can comprise a series of application-wrapped algorithms which evaluate the mapped dataflow of a given enterprise, and by following the data values as they pass through the enterprise, algorithmically determine the most efficient mapping for each mapped data element.

An automatic mapping tool typically automates mapping functions of the vast majority of enterprise data, utilizing network and database sniffer technology and advanced algorithms to determine the formal, functional, and power-based relationships within an organization, then relating all information traffic against those structures to primarily classify data relations. Secondly, automatic mapper may recursively relate previously classified data to organizational structures allowing for the ontology mapping of remaining fields. Thirdly, an automatic mapper may include advanced algorithms that can determine shifts in unstructured data within the previously ascertained structures to further refine the classifications.

### Notional Examples of Partial Implementation Using Mapper & Modeler

Certain aspects of the present invention can change focus from the past and provide a holistic view of information to assist decision making. In the example of the national car rental company described above, systems and methods provided according to certain aspects of the invention allow modeling of the factors of demand coupled with exigent and dynamic market conditions (e.g. conferences, major migration patterns, etc.) This case is representative of how the present invention can resolve complex and ongoing problems using a model with a full understanding of the inputs and outputs is needed to optimize the size, deployment, and movement of fleet assets.

In another example, manufacturing company A is seeking to lower its cost and management decides to do away with overtime with a potential for millions of dollars in savings related to HR overhead. However, suppose that an effect of this decision is that shipping costs go up 4.5× because a slight delay in production gives rise to more overnight shipments and other more expensive shipping methods are required to meet delivery requirements. In the example, a manager who saved on overtime may have been rewarded although the net effect of this decision to company A was substantially negative. Moreover, when the shipping manager realizes that a shift in costs had occurred, the cause may be obscured by rising fuel and shipping rates and it may be difficult to properly attribute and unravel the causal links of the shipping costs and to bring them under control.

Thus, embodiments of the present invention attempt to determine connections between causes and effects in ways that are not always obvious to even the most astute managers. Simply our, business can be modeled and simulated to enlighten decision-making and, in turn, systemically optimize performance. Businesses that employ tools according to certain aspects of the invention will provide a competitive advantage

### Orientation Markers

In certain embodiments, the mapping process can be effectively commenced by introducing all Factors, then Metrics and, finally, all Reports. This sequence of operations can typically prevent or lessen the need for a user to stop mapping a data element in mid-stream in order to map a child thread, before returning to the original mapping activity. However, in certain embodiments, the data entry function can be automated, whereby Factors, Metrics and reports can be parsed, sorted and entered with minimal user intervention. Sequencing may be less significant during automated entry since the automation process can include checkpoints and branches and/or parallel entry processes.

Certain embodiments of the invention provide capabilities to catalog enterprise-related data through a given ontology, relate each data element to the enterprise as a meta-tagged variable, and enable both real-time and time-late advance analysis on enterprise performance. Luminosity systems overlay and harvest data from existing enterprise systems and make this data available to customized learning models that reside on our modeling platform. Analytic scientists develop, then employ specialty/custom models which integrate into the user enterprise, making all enterprise data of the business systems available to customized math and learning models. An assessment service facilitates ongoing monitoring and analysis of internal and external factors of import, including, audit, overall business health, and industry benchmarking, process verification and optimization, and comparative trend analysis.

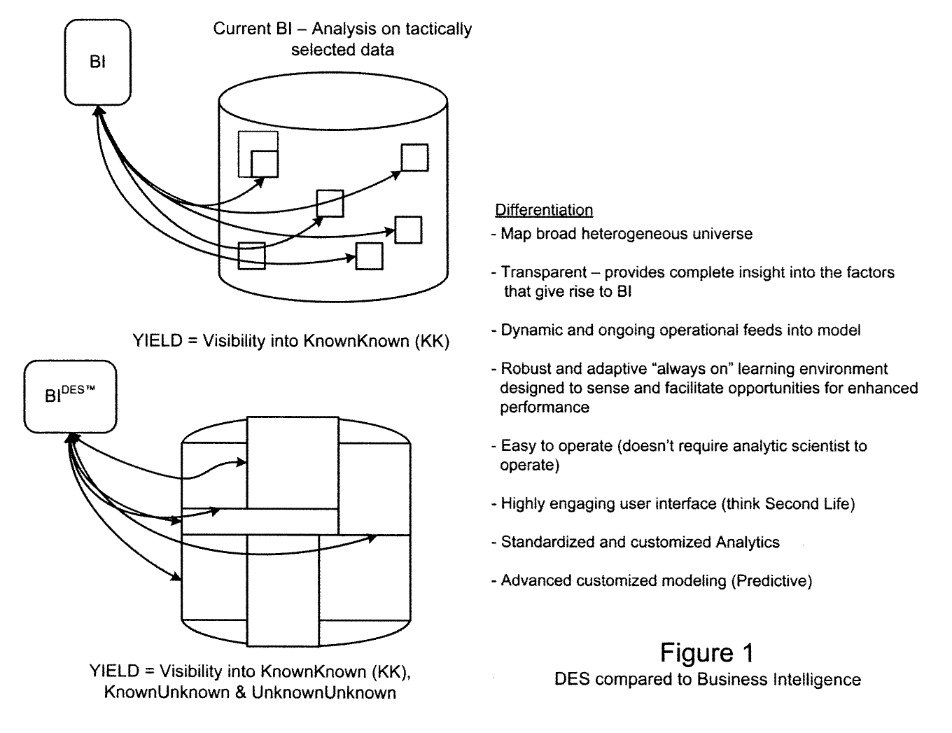

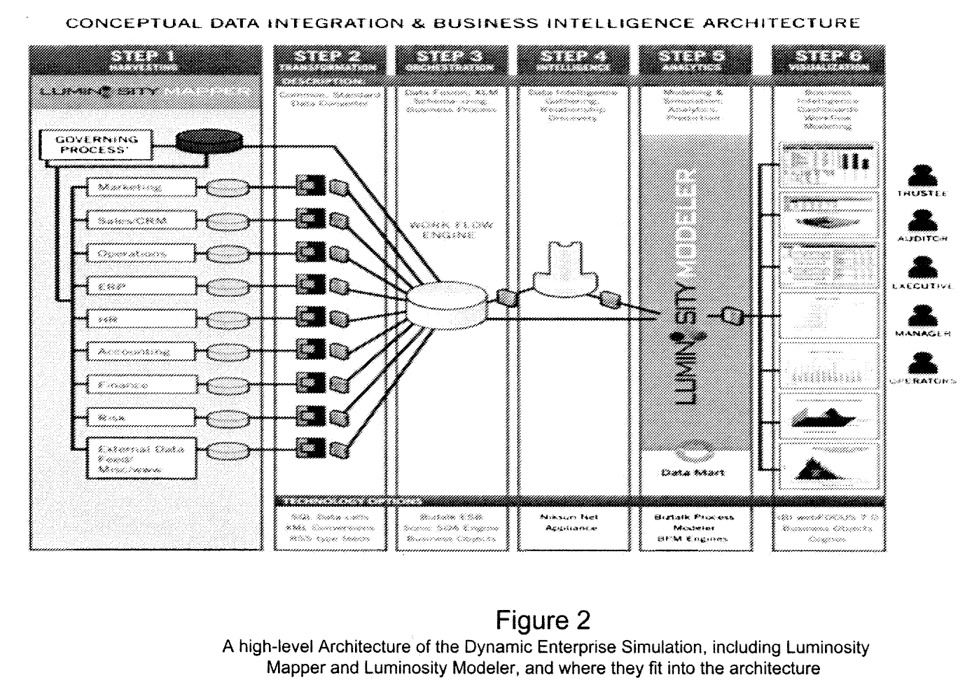

With reference to FIGS. 1 and 2, certain embodiments provide broader visibility into enterprise data. FIG. 2 shows a six step process that may assist understanding of certain aspects of the invention. In step 1, data is harvested from a variety of sources of information. These sources may include databases, mass storage and information obtained from business systems such as accounting, purchasing, decision support and other systems, including external data sources. At step 2, information from the various sources can be categorized, sorted and transformed to a common form, standard and/or storage format using a data converter. Information may include raw and processed data, compilations of data and information, indices, glossaries and queries. Any suitable common form may be selected; typical forms may include standard database formats, SQL data calls, XML and so on. Data may be collected and converted using XML conversion utilities, SQL calls and RSS-type feeds. Data may then be orchestrated at step 3. Orchestration may include processes for data fusion, schema-izing and other business processes known in the art. Proprietary and commercially available tools may be employed including Biztalk ESB, Sonic SOA Engine and Business Objects. At step 4, intelligence gathering and relationship discovery may be performed. In one example, a Niksum Net Appliance may be adapted to provide intelligence gathering capabilities. Information may then be processed through analytics at step 5. Analytics can also include modeling, simulation and prediction. At step 6, one or more visualization processes can produce output for use by other systems, for viewing by users and for report generation.

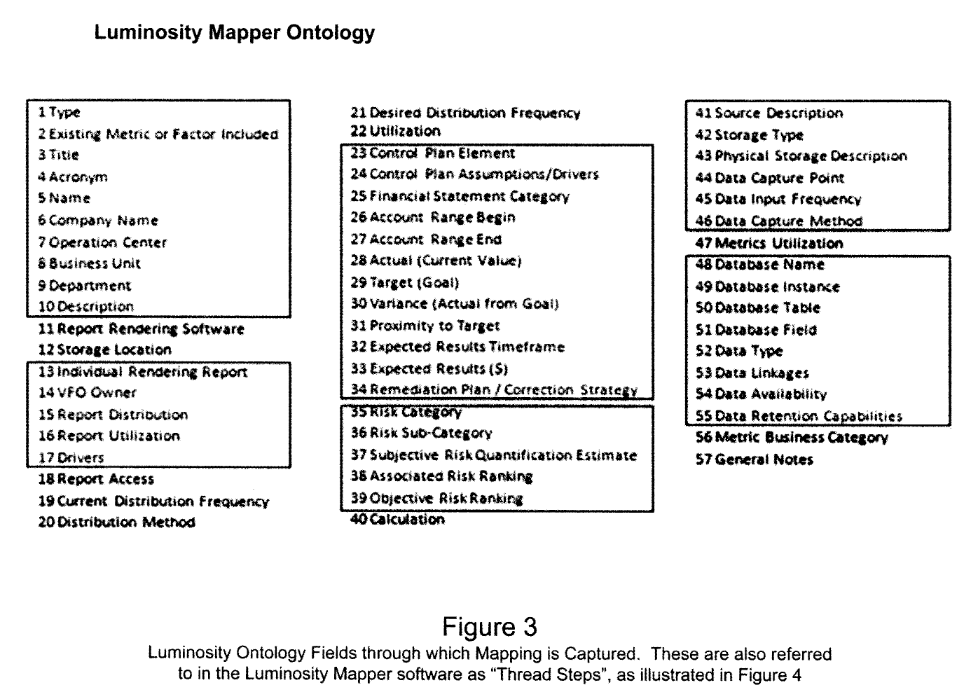

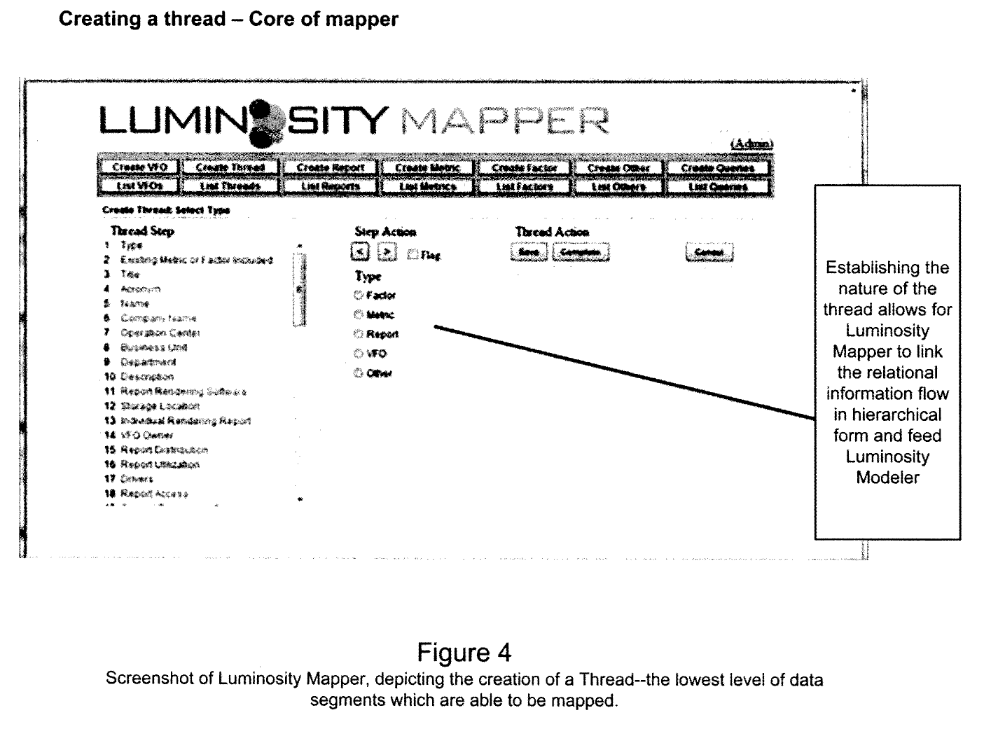

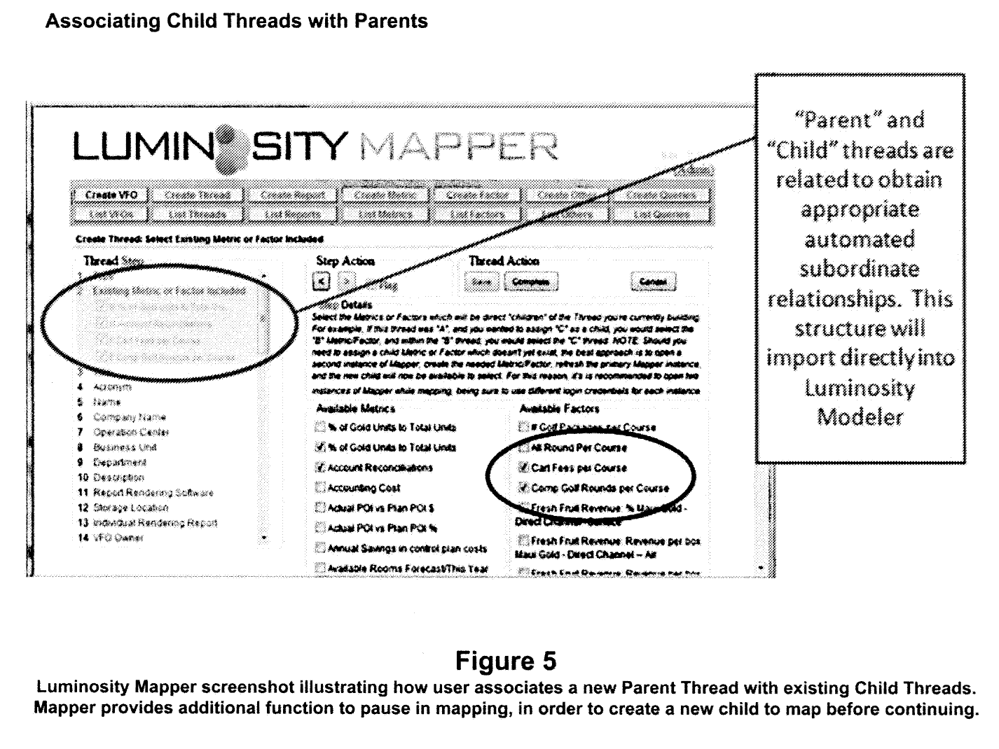

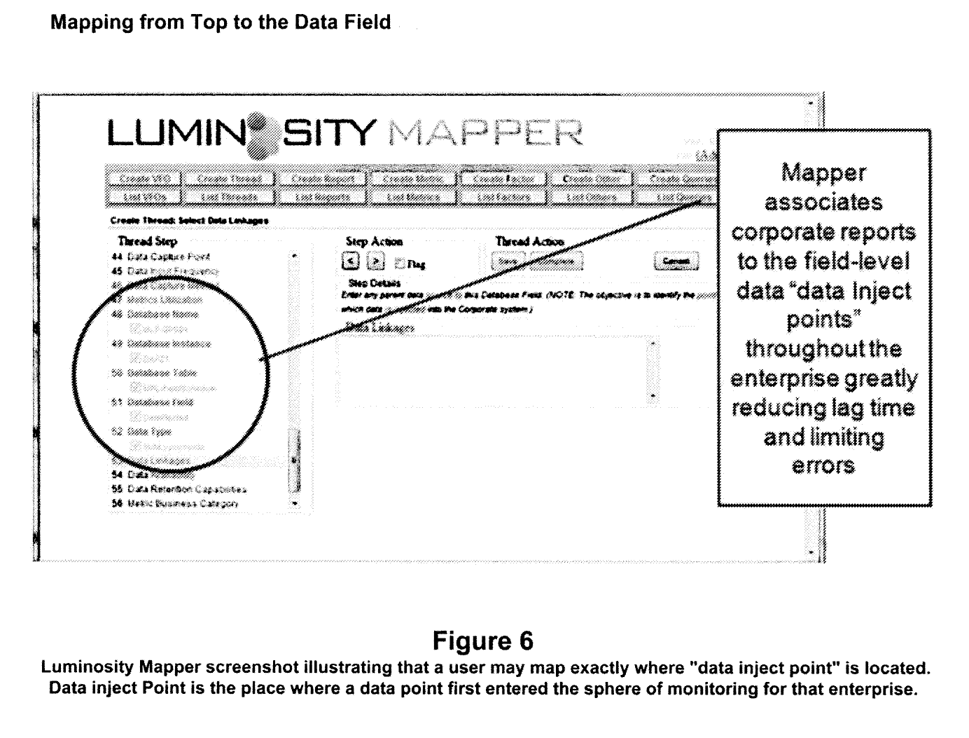

FIG. 3 provides an example of a mapper ontology according to certain aspects of the invention. The example draws out ontology fields through which mapping can be captured. The screenshots of FIGS. 4-9 illustrate certain aspects of the invention. FIG. 4 shows a mapper screenshot which depicts the creation of a thread, wherein the thread are the lowest level of data segments which are able to be mapped. FIG. 5 shows a mapper screenshot which depicts a method by which a user associates a new parent thread with one or more existing child threads. The mapper depicted provides an additional function to suspend the mapping, in order to create a new child for mapping. FIG. 6 shows a mapper screenshot which depicts a method by which a user may map exactly where a “data inject point” is located. The data inject point may be understood as the place where a data point first entered the sphere of monitoring for an enterprise.

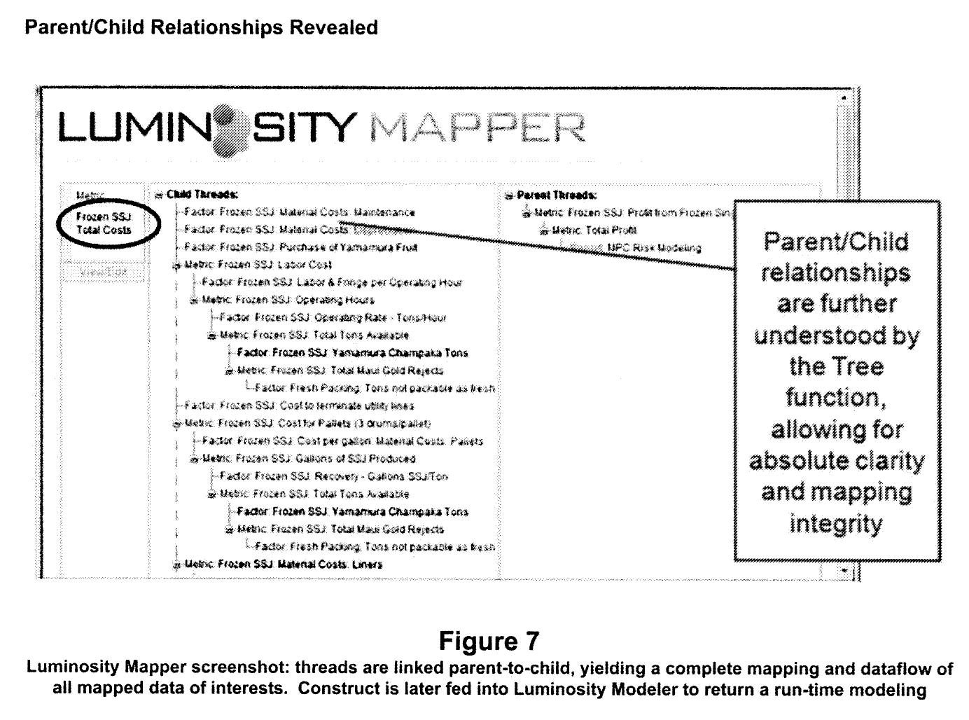

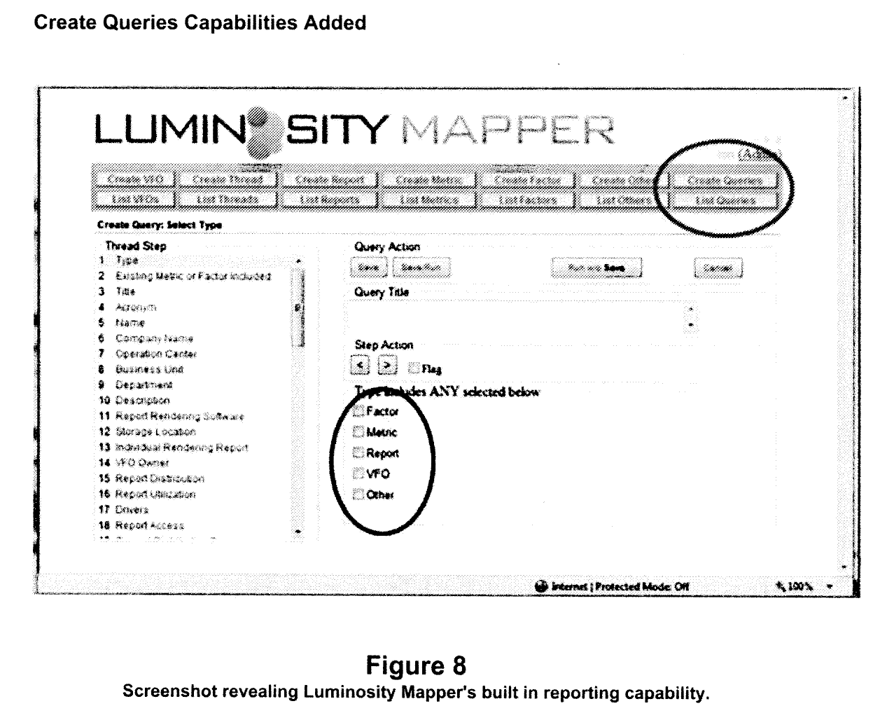

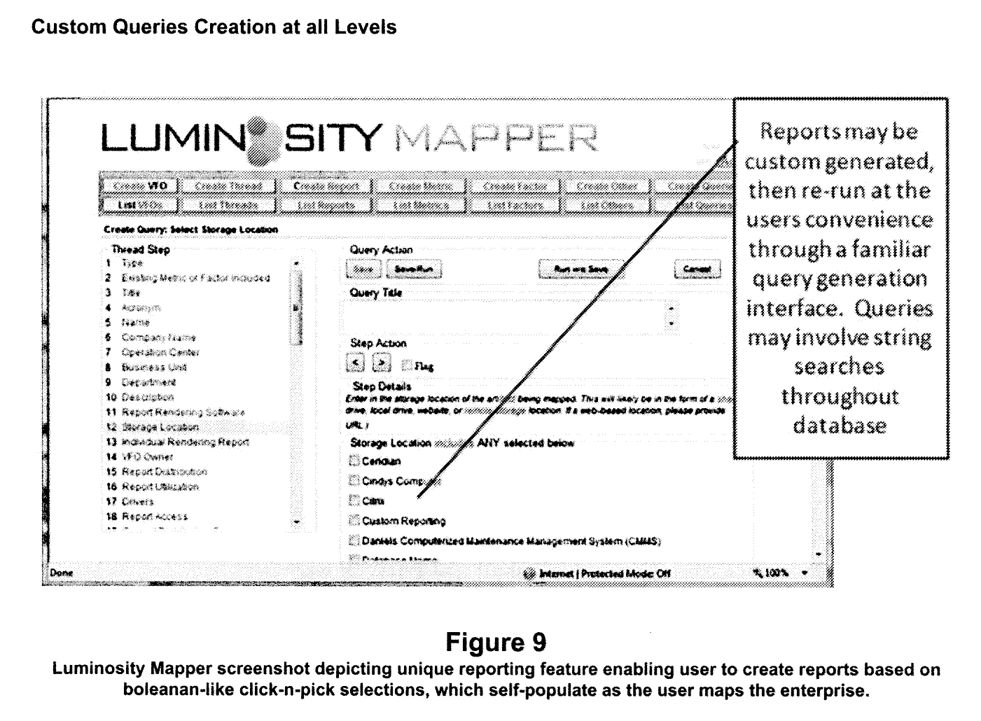

FIG. 7 shows a mapper screenshot which illustrates the linking between parent and child threads. Such linking may ultimately yield a complete mapping and data flow of all mapped data of interests. This construct may subsequently be provided to a modeler for run-time modeling. FIG. 8 shows a mapper screenshot which depicts one example of a mapper which has built-in reporting capability. FIG. 9 shows a mapper screenshot which depicts a reporting feature that enables a user to create reports based on Boolean-like click-n-pick selections, which self-populate as the user maps the enterprise.

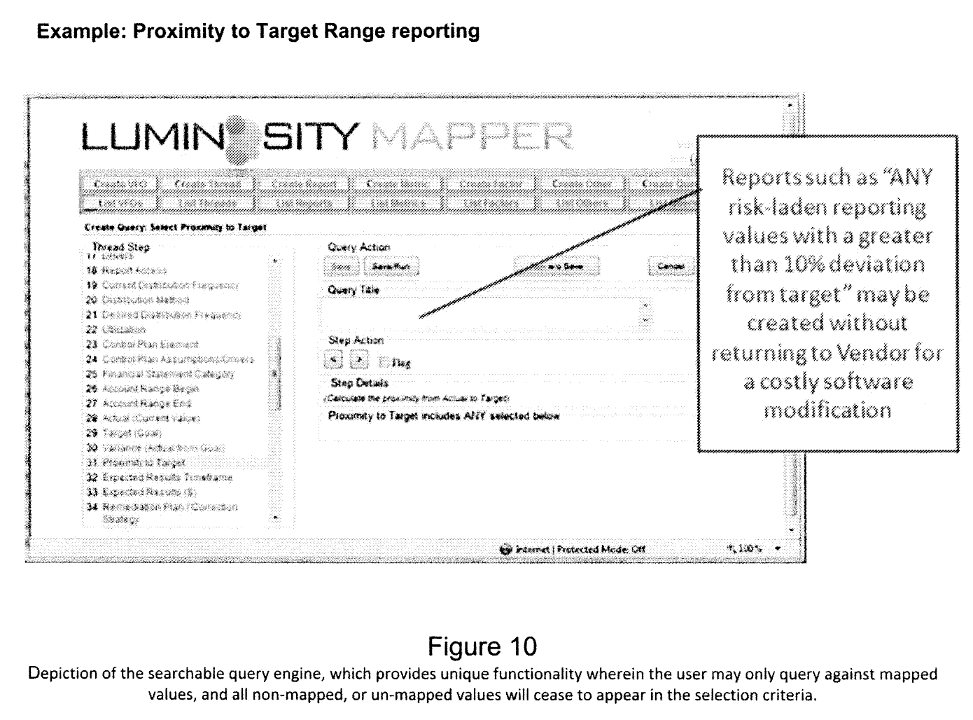

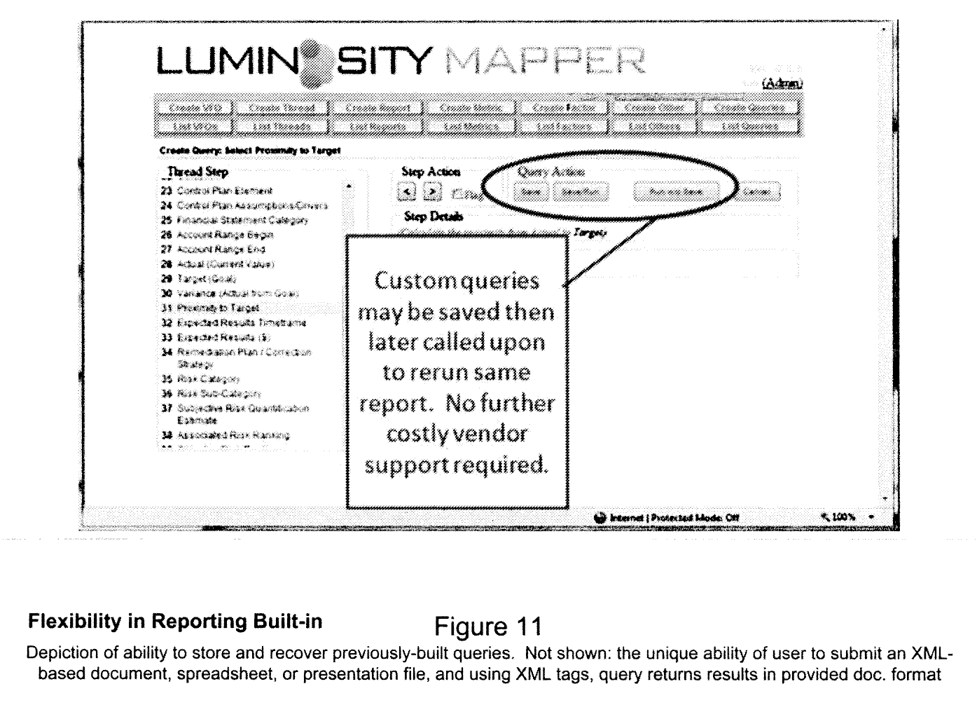

FIG. 10 is a depiction of a searchable query engine provided according to certain aspects of the invention. The query engine may permit the user query only against mapped values. In such embodiments, non-mapped and/or unmapped values may be suppressed such that they do not appear in the selection criteria. FIG. 11 depicts an ability of certain embodiments to store and recover previously-built queries. Not shown, in the screenshot, is the ability of the user to submit an XML-based document, spreadsheet, or presentation file such that the query returns the results in the provided document format using, for example, XML tags.

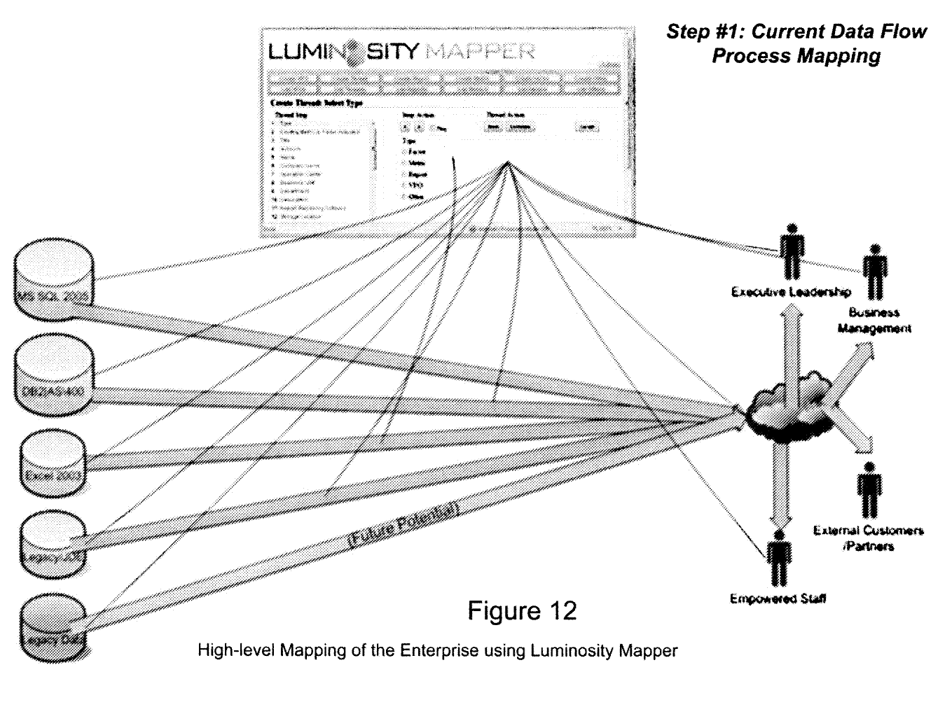

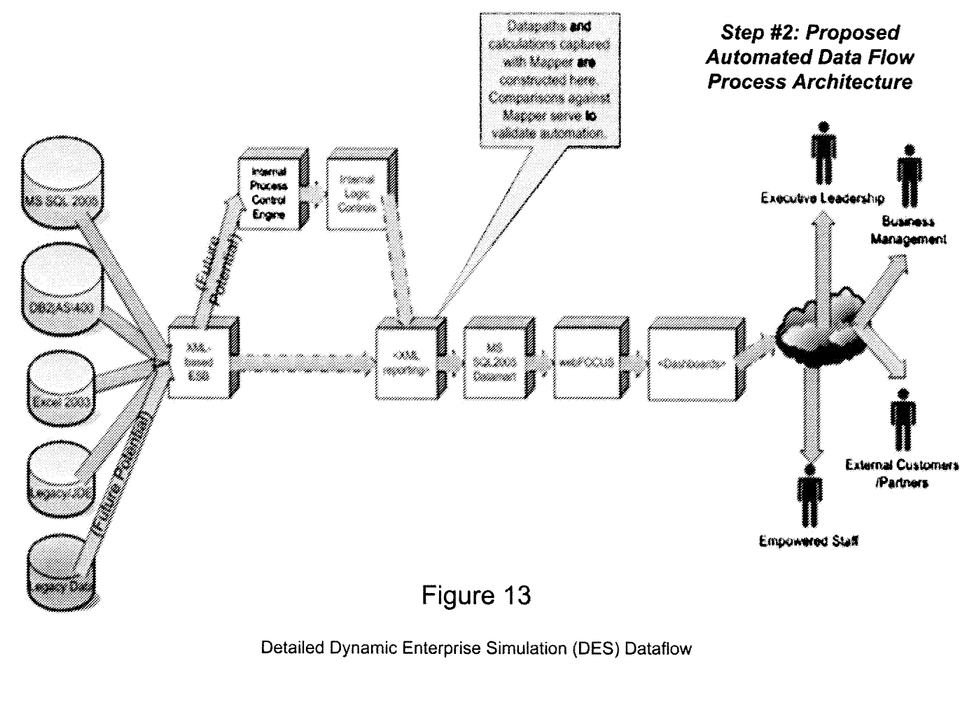

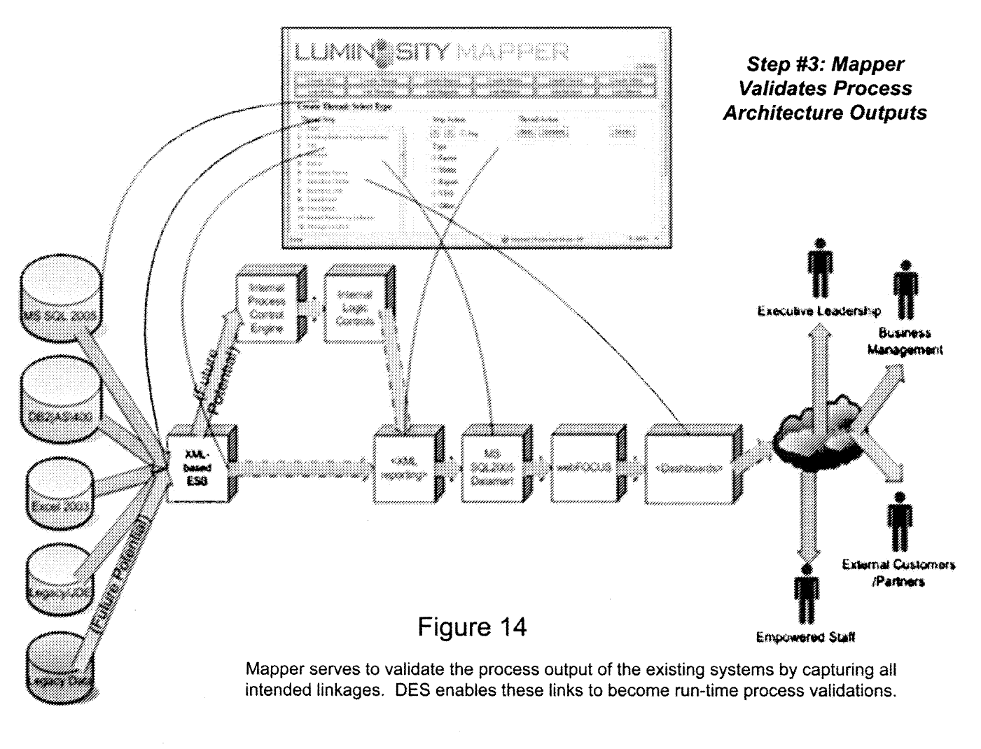

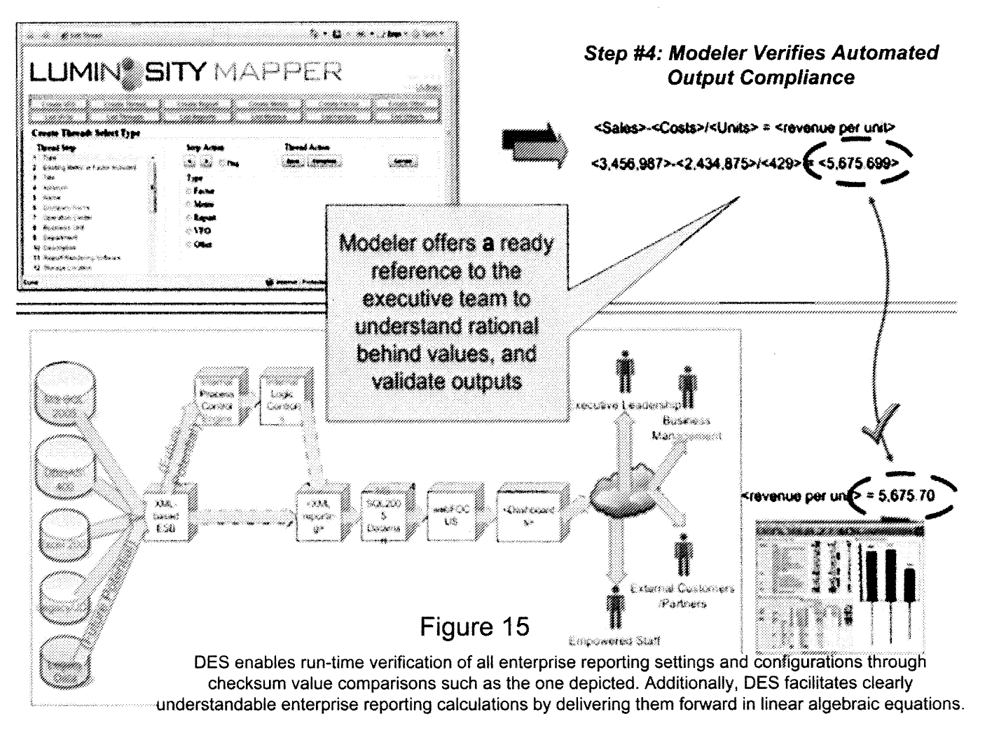

FIG. 12 illustrates a high-level mapping of an enterprise using a mapper provided according to certain aspects of the invention. FIG. 13 depicts an example of detailed DES data flow. FIG. 14 describes an example of a mapper validating the process output of the existing systems by capturing all intended linkages. DES can enable such links to become run-time process validations. FIG. 15 illustrates DES enabling run-time verification of enterprise reporting settings and configurations through checksum value comparisons such as the one depicted. Additionally, DES can facilitate clearly understandable enterprise reporting calculations by delivering them forward in linear algebraic equations.

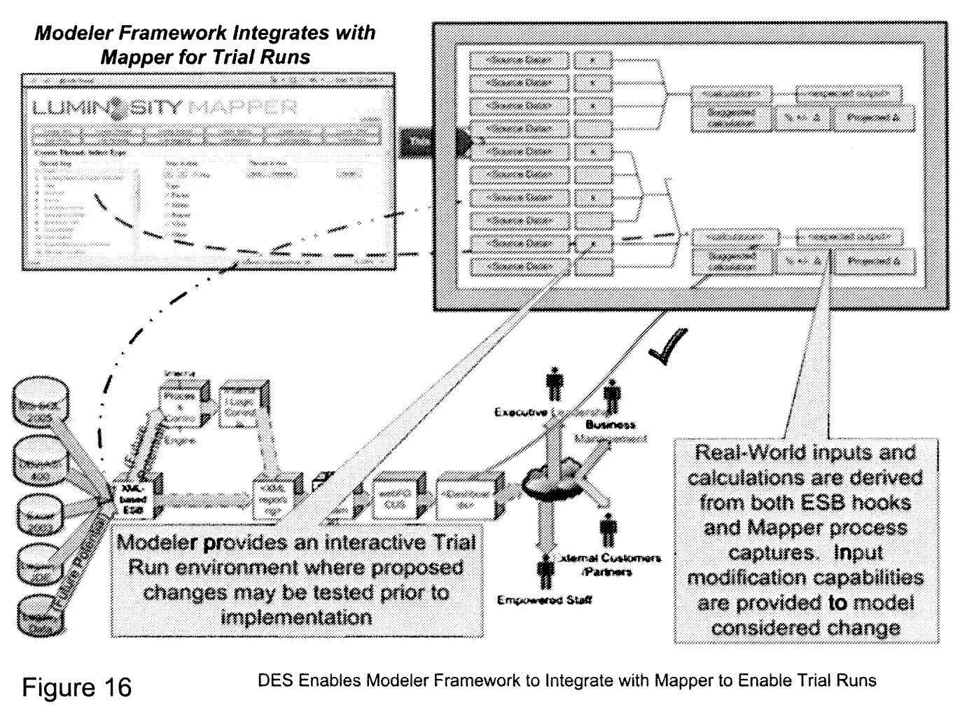

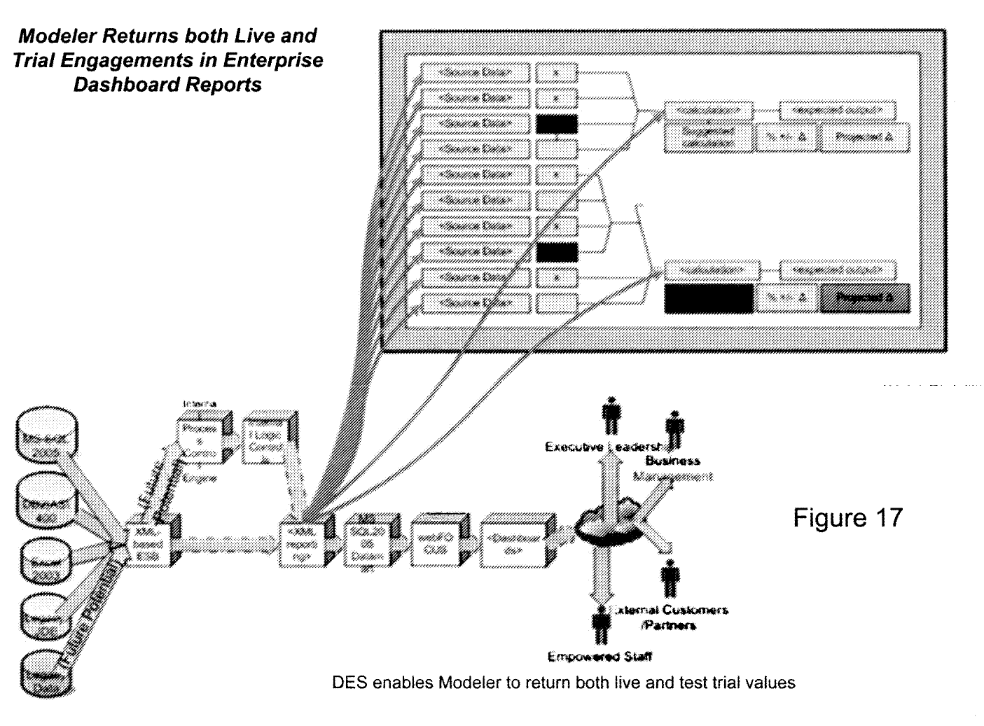

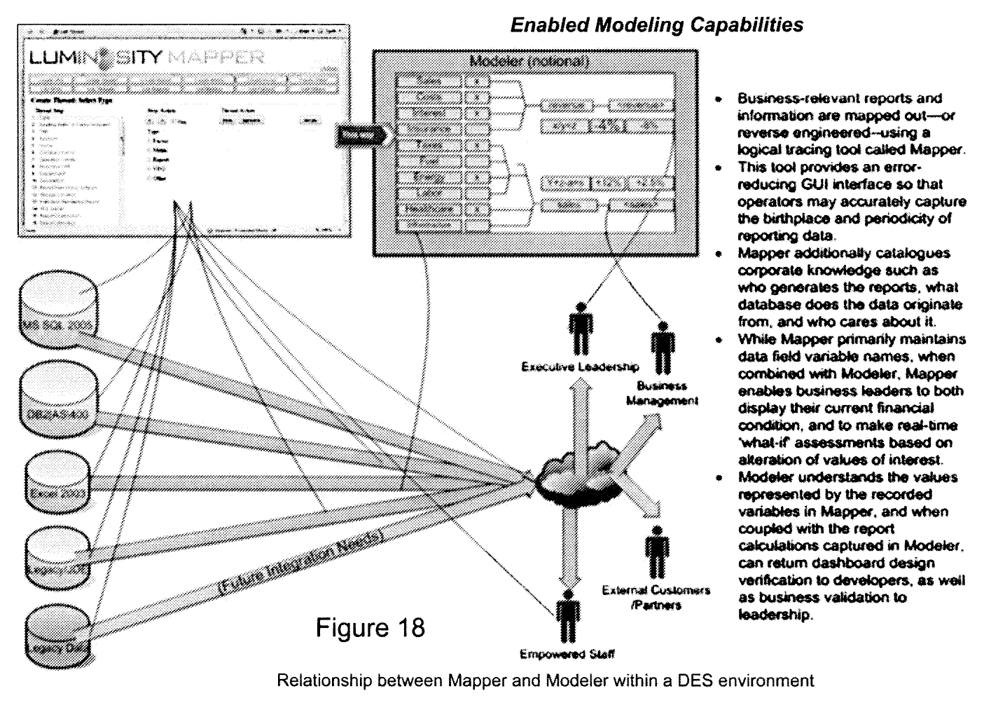

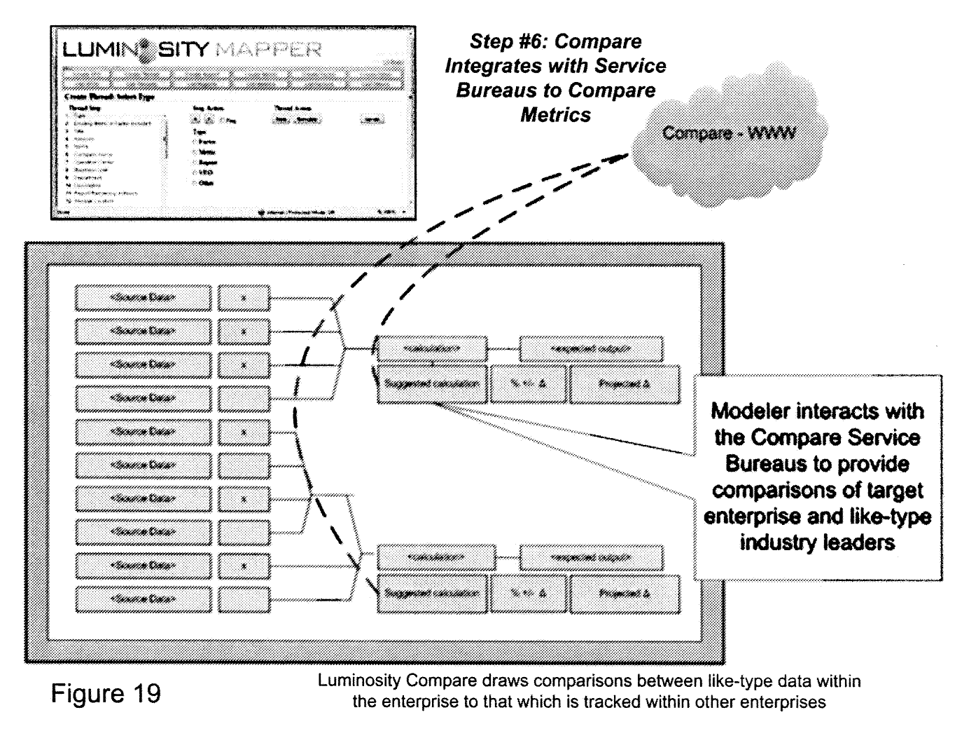

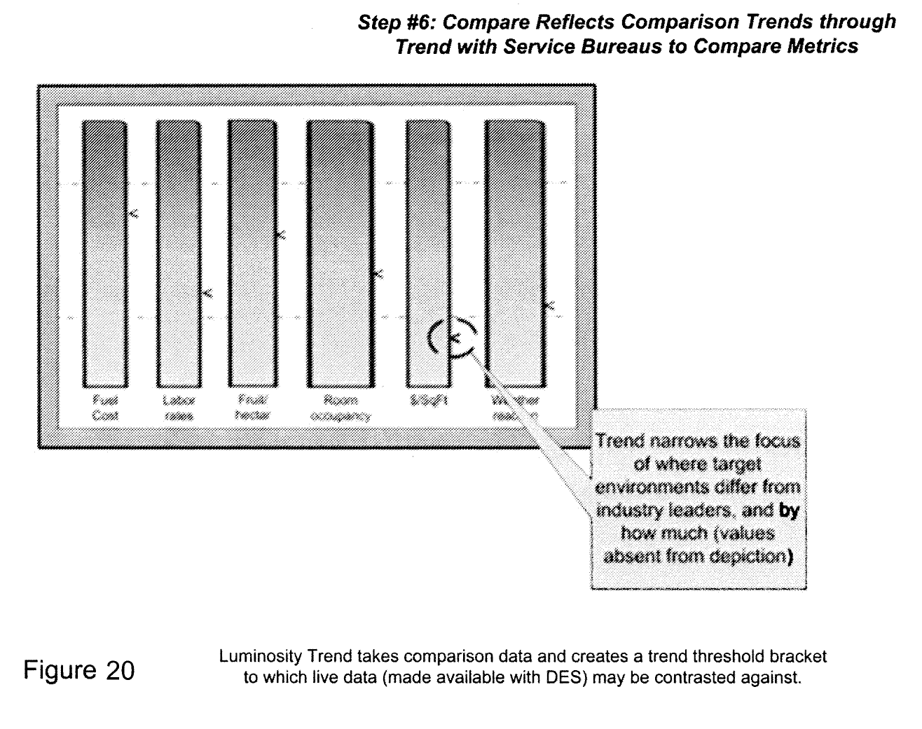

FIG. 16 illustrates an example showing how DES can enable a modeler framework to integrate with the mapper to enable trial runs. The example of FIG. 17 illustrates how a DES-enabled modeler can return both live and test trial values. FIG. 18 depicts the relationship between mapper and modeler in an example having a DES environment. FIG. 19 illustrates a comparison tool that draws comparisons between like-type data within the enterprise to that which is tracked within other enterprises. FIG. 20 illustrates the operation of a trending tool that takes comparison data and creates a trend threshold bracket to which live data (made available with DES) may be contrasted against.

### Additional Descriptions of Certain Aspects of the Invention

The foregoing descriptions of the invention are intended to be illustrative and not limiting. For example, those skilled in the art will appreciate that the invention can be practiced with various combinations of the functionalities and capabilities described above, and can include fewer or additional components than described above. Certain additional aspects and features of the invention are further set forth below, and can be obtained using the functionalities and components described in more detail above, as will be appreciated by those skilled in the art after being taught by the present disclosure.

Certain embodiments of the invention provide systems and methods for mapping enterprise data. Some of these embodiments comprise obtaining information associated with an enterprise from a plurality of sources. Some of these embodiments comprise transforming the information to obtain formatted data. Some of these embodiments comprise orchestrating the formatted data. Some of these embodiments comprise determining relationships between portions of the formatted data to obtain business intelligence related to the enterprise. Some of these embodiments comprise performing a plurality of analytics on the formatted data and business intelligence.

In some of these embodiments, the results of the determining relationships and performing analytics steps are provided to a visualizer configured to produce one or more reports for a user. In some of these embodiments, the plurality of sources includes databases, mass storage and information obtained from one or more business systems. In some of these embodiments, the one or more business system includes an accounting system. In some of these embodiments, the one or more business system includes a purchasing system. In some of these embodiments, the one or more business system includes a decision support system.

In some of these embodiments, the plurality of sources includes data sources external to the enterprise. In some of these embodiments, the step of transforming the information includes categorizing and sorting the information before transforming the information to a predetermined data format. In some of these embodiments, the predetermined data format includes an XML format. In some of these embodiments, the information is obtained using an SQL call. In some of these embodiments, the information is obtained using an RSS feed. In some of these embodiments, the information is obtained using an XML convert utility.

In some of these embodiments, the results are employed by one or more tools, the tools comprising a mapper, a reporter, a modeler, a gateway, a proofing tool, a trend analysis tool, a historical/audit tool, a process mapper, a process optimization tool and an automatic mapper.

Certain embodiments comprise DES-compliant tools. In certain embodiments DES compliant tools include a mapper, a reporter, a modeler, a gateway, a proofing tool, a trend analysis tool, a historical/audit tool, a process mapper, a process optimization tool and an automatic mapper.

In some of these embodiments, the systems and methods include systems and methods for mapping a data construct for an enterprise. In some of these embodiments, data points are linked so that the enterprise's data flow may be reproduced in representational entirety, making it available for run-time analysis without interrupting the enterprise. In some of these embodiments, methods effectively map the entire data structure of an enterprise.

Certain embodiments of the invention provide systems and methods for effectively mapping the entire data structure of an enterprise, such that each element and relationship is easily available for inspection by an ordinary reasonable prudent person. Some of these embodiments comprise methods for capturing quantifiable and non-quantifiable risks and opportunities, associating them to a data element, or a parent of one or more data elements. Some of these embodiments comprise methods for effectively synchronizing data distribution and data updates with data reporting, at the individual data element level. Some of these embodiments comprise methods for capturing threshold limits for each data element, or parent of one or more data elements, allowing for advanced analytics to be performed at the data element level.

Certain embodiments of the invention provide systems and methods for conducting run-time volatility analysis on datasets, using the user-identified threshold limits recorded at the time of mapping. Some of these embodiments comprise methods for effectively assigning risk at the data element level (or above). Some of these embodiments comprise methods for effectively capturing the discreet mathematics which are required to create roll-up business intelligence dashboards, and do so in a way which enables the reviewer to easily understand the data handling taking place. Some of these embodiments comprise methods that effectively identify the to-be affected system(s) of a planned technology refresh activity.

Certain embodiments of the invention provide systems and methods for automating output compliance of the enterprise data. Some of these embodiments comprise methods that enable a user to create a trial run, or what-if scenario using run-time data, which will yield true run-time output(s) during said test. Some of these embodiments comprise methods that enable users to create data interrupt points at any stage in the data path, yielding a what-if scenario. Some of these embodiments comprise methods for creating a comparison between data-level performances of one enterprise against another. Some of these embodiments comprise methods for creating and providing trending data at the data element level, for the entire enterprise, and when coupled with Luminosity Compare, create a trending baseline from which to compare the enterprise against. Some of these embodiments comprise methods for auto-constituting a query capability based directly on the previous inputs of the user. Some of these embodiments comprise methods that enable a user to extract query results directly into any XML-based office productivity tool template.

Certain embodiments of the invention provide systems and methods for mapping the data construct for a given enterprise, wherein data points are linked so that the enterprise's data flow may be reproduced in representational entirety, making it available for run-time analysis without interrupting the enterprise. Some of these embodiments comprise tools for effectively mapping the entire data structure of an enterprise. Some of these embodiments comprise tools for effectively mapping the entire data structure of an enterprise, such that each element and relationship is easily available for inspection by an ordinary reasonable prudent person. Some of these embodiments comprise tools for capturing quantifiable and non-quantifiable risks and opportunities, associating them to a data element, or a parent of one or more data elements. Some of these embodiments comprise tools for effectively synchronizing data distribution and data updates with data reporting, at the individual data element level.

Some of these embodiments comprise tools for capturing threshold limits for each data element, or parent of one or more data elements, allowing for advanced analytics to be performed at the data element level. Some of these embodiments comprise tools for conducting run-time volatility analysis on datasets, using the user-identified threshold limits recorded at the time of mapping. Some of these embodiments comprise tools for effectively assigning risk at the data element level (or above). Some of these embodiments comprise tools that effectively capture the discreet mathematics which are required to create roll-up Business Intelligence dashboards, and do so in a way which enables the reviewer to easily understand the data handling taking place. Some of these embodiments comprise tools that effectively identify the to-be affected system(s) of a planned technology refresh activity.

Certain embodiments of the invention provide systems and methods for automating output compliance of the enterprise data. Some of these embodiments comprise tools that enable the user to create a trial run, or what-if scenario using run-time data, which will yield true run-time output(s) during said test. Some of these embodiments comprise tools that enable users to create data interrupt points at any stage in the data path, yielding a what-if scenario. Some of these embodiments comprise tools for creating a comparison between the data-level performances of one enterprise against another. Some of these embodiments comprise tools for creating and providing trending data at the data element level, for the entire enterprise, and when coupled with Luminosity Compare, create a trending baseline from which to compare the enterprise against. Some of these embodiments comprise tools that auto-constitute a query capability based directly on the previous inputs of the user. Some of these embodiments comprise tools that enable a user to extract query results directly into any XML-based office productivity tool template.

Although the present invention has been described with reference to specific exemplary embodiments, it will be evident to one of ordinary skill in the art that various modifications and changes may be made to these embodiments without departing from the broader spirit and scope of the invention. Accordingly, the specification and drawings are to be regarded in an illustrative rather than a restrictive sense.

What is claimed is:

1. A method, comprising:
obtaining information associated with an enterprise from a plurality of sources;
transforming the information to obtain formatted data;
orchestrating the formatted data;
determining relationships between portions of the formatted data to obtain business intelligence related to the enterprise; and
performing a plurality of analytics on the formatted data and business intelligence, wherein results of the determining relationships and performing analytics steps are provided to a visualizer configured to produce one or more reports for a user.

2. The method of claim 1, wherein the plurality of sources includes databases, mass storage and information obtained from a business system.

3. The method of claim 2, wherein the business system is an accounting system.

4. The method of claim 2, wherein the business system is a purchasing system.

5. The method of claim 2, wherein the business system is a decision support system.

6. The method of claim 1, wherein the plurality of sources includes data sources external to the enterprise.

7. The method of claim 1, wherein the step of transforming the information includes categorizing and sorting the information before transforming the information to a predetermined data format.

8. The method of claim 7, wherein the predetermined data format includes XML format.

9. The method of claim 1, wherein the information is obtained using one or more of an SQL call and RSS feed.

10. The method of claim 1, wherein the results are employed by one or more tools, the tools comprising a mapper, a reporter, a modeler, a gateway, a proofing tool, a trend analysis tool, a historical/audit tool, a process mapper, a process optimization tool and an automatic mapper.
